(19) United States
(12) Patent Application Publication
(10) Pub. No.: US 2025/0269611 A1
(43) Pub. Date: Aug. 28, 2025

(54) FUSION TIP, HEAT FUSION MACHINE INCLUDING THE SAME, AND HEAT FUSION METHOD USING THE SAME

(71) Applicant: SK On Co., Ltd., Seoul (KR)

(72) Inventors: Dong Hyee LEE, Daejeon (KR); Byeong Jun PAK, Daejeon (KR); Hoemin CHEONG, Daejeon (KR); Seung Hoon JU, Daejeon (KR)

(21) Appl. No.: 18/974,791

(22) Filed: Dec. 10, 2024

(30) Foreign Application Priority Data
Feb. 22, 2024 (KR) 10-2024-0025628

(51) Int. Cl. B29C 65/00; B29C 65/60; B29L 31/34; H01M 10/04

(52) U.S. Cl. CPC B29C 66/81453; B29C 65/606; B29C 66/81423; B29C 66/824; B29C 66/8322; H01M 10/0404; B29L 2031/3468

(57) ABSTRACT

A fusion tip of a heat fusion machine assembling a sub-material including a boss or rib with a base material and then heat-fusing the boss or rib to fix the sub-material and the base material includes a base tip including a pinhole formed vertically in a center and a tip head contacting the boss or rib during heat fusion and a fusion pin positioned in the pinhole and configured to move up and down separately from the base tip.

### CROSS-REFERENCE TO RELATED APPLICATION(S)

This patent document claims the priority and benefits of Korean Patent Application No. 10-2024-0025628 filed on Feb. 22, 2024, the disclosure of which is incorporated herein by reference in its entirety.

### TECHNICAL FIELD

The disclosure and implementations disclosed in this patent document generally relate to a fusion tip, a heat fusion machine including the same, and a heat fusion method using the same.

### BACKGROUND

Heat fusion is also called thermoplastic fusion and refers to a method of joining two different materials. It is a technology of transferring thermal energy to a surface of a product formed 1 of a thermoplastic resin, raising a temperature of the surface of the product to be joined to the melting point thereof, and then pressing and cooling to join the materials.

For example, in the case of joining two different materials of a base material and a sub-material by heat fusion, a boss or rib formed in the sub-material is inserted into the base material, and the inserted boss or rib is heated, compressed, and then cooled to deform the shape of the boss or rib. The base material and the sub-material are fixedly joined by the deformed boss or rib.

Meanwhile, the heat fusion method may be applied in the process of manufacturing a battery cell, a battery module, or a battery pack.

### SUMMARY

Meanwhile, in the case of inserting the boss or rib of the sub-material into an insertion hole formed in the base material and then heat-fusing the same, a gap, an empty space, may be formed between the boss or rib and the insertion hole. The gap may form a space in which the sub-material is not fixed to the base material and may move, thereby reducing bonding force between the sub-material and the base material.

The present disclosure may be implemented in some embodiments to reduce a gap formed between a sub-material and a base material.

The present disclosure may be implemented in some embodiments to provide a heat fusion method capable of increasing bonding force.

In some embodiments of the present disclosure, a fusion tip of a heat fusion machine assembling a sub-material including a boss or rib with a base material and then heat-fusing the boss or rib to fix the sub-material and the base material includes: a base tip including a pinhole formed vertically in a center and a tip head contacting the boss or rib during heat fusion; and a fusion pin positioned in the pinhole and configured to move up and down separately from the base tip.

The fusion pin may include a body portion and an auxiliary pin, and the auxiliary pin may have a cross-sectional area smaller than that of the body portion and may be disposed toward the boss or rib.

The auxiliary pin may include a first auxiliary pin having a cross-sectional area smaller than that of the body portion and a second auxiliary pin having a cross-sectional area smaller than that of the first auxiliary pin, and the first auxiliary pin and the second auxiliary pin may be arranged toward the boss or rib.

The auxiliary pin may protrude toward the boss or rib to be fixed.

The auxiliary pin may be embedded in the body portion and may be configured to protrude toward the boss or rib during heat fusion.

The fusion pin may include a pin head contacting the boss or rib, and the pin head may include an intagliated portion recessed into the interior of the fusion pin.

The fusion pin may include a pin head contacting the boss or rib, and the pin head may include a coating layer on a surface contacting the boss or rib.

The fusion tip may further include: an elastic body connected to the fusion pin, wherein the elastic body is configured to be compressed during heat fusion so that the fusion pin is accommodated in the pinhole.

In some embodiments of the present disclosure, a heat fusion machine assembling a sub-material including a boss or rib with a base material and then heat-fusing the boss or rib to fix the sub-material and the base material includes: a fusion tip; and a moving member, wherein the fusion tip includes: a base tip including a pinhole formed vertically in a center and a tip head contacting the boss or rib during heat fusion; and a fusion pin positioned in the pinhole and configured to move up and down separately from the base tip, and wherein the moving member is connected to the fusion pin and configured to move the fusion pin up and down.

The moving member may include a motor and a driving shaft connected to the fusion pin, and the motor may rotate the driving shaft to move the fusion pin up and down.

The moving member may include an actuator connected to the fusion pin, and the actuator may move the piston to move the fusion pin up and down.

In some embodiments of the present disclosure, a heat fusion method includes: a preparatory operation of preparing a base material having an insertion hole into which a boss or rib of a sub-material is inserted; a first fusion operation of heating and pressing a central portion of the boss or rib to fill a space between the boss or rib and the insertion hole of the base material; and a second fusion operation of heating and pressing the remaining portion of the boss or rib to fix the sub-material and the base material, wherein, in the first fusion operation and the second fusion operation, the boss or rib is heated and pressed using a fusion tip including a base tip and a fusion pin configured to move up and down separately from the base tip.

In the first fusion operation, the fusion pin may move downwardly separately from the base tip to heat and press the central portion of the boss or rib.

In the second fusion operation, the remaining portion of the boss or rib may be heated and pressed with the base tip, while the central portion of the boss or rib is pressed with the fusion pin.

The preparatory operation may be an operation of preparing the sub-material and the base material included in a battery assembly.

### BRIEF DESCRIPTION OF DRAWINGS

Certain aspects, features, and advantages of the present disclosure are illustrated by the following detailed description with reference to the accompanying drawings.

FIGS. 1A and 1B are flowcharts illustrating heat fusion using a fusion tip of the related art.

FIG. 2 is a perspective view illustrating a fusion tip according to the present disclosure, and

FIGS. 3A, 3B, 4A, and 4B are flowcharts illustrating heat fusion using a fusion tip according to the present disclosure.

FIGS. 5A and 5B are cross-sectional views illustrating modified examples of a fusion pin.

FIGS. 6A and 6B are cross-sectional views illustrating another modified example of a fusion pin.

FIGS. 7A and 7B are cross-sectional views illustrating modified examples of a pin head of a fusion pin.

FIGS. 8A and 8B are cross-sectional views illustrating a fusion tip including an elastic body.

FIGS. 9A and 9B are cross-sectional views illustrating a portion of a heat fusion machine according to the present disclosure.

FIG. 10 is a cross-sectional view illustrating a portion of a battery cell to which a heat fusion method according to the present disclosure is applied.

FIG. 11 is a cross-sectional view illustrating a battery module to which a heat fusion method according to the present disclosure is applied.

FIG. 12 is a plan view illustrating a battery pack to which a heat fusion method according to the present disclosure is applied.

### DETAILED DESCRIPTION

Hereinafter, exemplary embodiments of the present disclosure will be described with reference to the accompanying drawings. For convenience, in the following description, a detailed description that obscures the technical gist of the present disclosure or for a known component will be omitted.

The following embodiments are provided to more completely describe the present disclosure to those skilled in the art to which the present disclosure pertains. The following exemplary embodiments are provided to aid understanding of the present disclosure, and the technical idea of the present disclosure is not necessarily limited to the specific exemplary embodiments described below. The present disclosure should be understood to broadly include various types of equivalents, substitutes, conversions, etc. that implement the technical ideas described in the following exemplary embodiments.

Terms used in the following exemplary embodiments are provided to more completely describe specific exemplary embodiments from the viewpoint. Accordingly, the terms used in the following exemplary embodiments should not be construed to reduce, limit, or restrict the technical idea of the present disclosure.

In the following description, singular expressions may be interpreted to include plurality unless clearly excluded in the context. In addition, the expression “including” in the following description means that a component, a part, an operation, a feature, an operation, a number, etc. described in the description exist, and does not mean that addition of and one or more other components, parts, operations, features, operations, numbers, etc. are excluded.

Prior to the description of the present disclosure, terms and words used in the present specification and claims to be described below should not be construed as limited to ordinary or dictionary terms, and should be construed in accordance with the technical idea of the present disclosure based on the principle that the inventors may properly define their own inventions in terms of terms in order to best explain the invention. Therefore, the embodiments described in the present specification and the configurations illustrated in the drawings are merely the most preferred embodiments of the present disclosure and are not intended to represent all of the technical ideas of the present disclosure, and thus should be understood that various equivalents and modifications may be substituted at the time of the present application.

Hereinafter, preferred embodiments of the present invention will be described in detail with reference to the accompanying drawings. In this case, in the drawings, the same components are denoted by the same reference symbols as possible. Further, the detailed description of well-known functions and constructions which may obscure the gist of the present invention will be omitted. For the same reason, some of the elements in the accompanying drawings are exaggerated, omitted, or schematically illustrated, and the size of each element does not entirely reflect the actual size. In addition, in the present specification, the expressions, such as an upper side, a lower side, a side face, and the like, are described based on the drawings and may be expressed differently when the direction of the corresponding object is changed.

Hereinafter, a fusion tip, a heat fusion machine including the same, and a heat fusion method using the same according to the present disclosure are specifically described with reference to drawings.

The fusion tip according to the present disclosure may be a component of a heat fusion machine. The heat fusion machine may be a device that fixes a sub-material and a base material. The sub-material may be a material melted when heated to be changed in shape, and deformed when cooled to be solidified in the shape as it is. For example, the sub- material may include a thermoplastic plastic. The sub- material may include a boss or rib. The boss or rib is configured to be inserted into the base material and may include a protrusion shape. The base material may include an insertion hole formed to allow the boss or rib to be inserted thereinto. The base material and the sub-material may be assembled by inserting the boss or rib into the insertion hole. After assembly, the heat fusion machine may heat and press the boss or rib inserted into the insertion hole with the fusion tip to change the shape thereof and cool the same to join the base material and the sub-material.

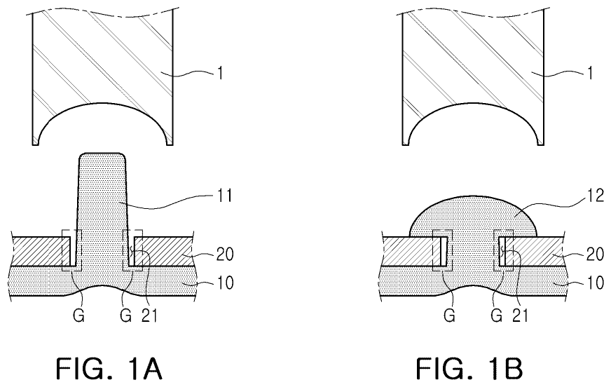

FIGS. 1A and 1B are flowcharts illustrating heat fusion using the related art fusion tip 1. FIG. 1A is a state before fusion, and FIG. 1B is a state after fusion.

Referring to FIGS. 1A and 1B, a gap G may not be filled after heat fusion. The gap G may be an empty space between the boss or rib 11 and the base material 20. The end of the fusion tip 1 may have a shape rounded toward the inside of the fusion tip 1. When heat fusion is performed using the fusion tip 1, the boss or rib 11 may be melted and moved. A lower portion of the melted boss or rib 11 may have a small degree of deformation in a horizontal direction, so the gap G may not be filled.

For example, during heat fusion, an upper portion of the melted boss or rib 11 may be deformed while moving upwardly in the horizontal direction along the round shape of the fusion tip 1, and the amount of downwardly movement may not be sufficient to fill the gap G. The gap G formed in the insertion hole 21 may provide a space in which the boss or rib 11 may move sufficiently. Accordingly, the sub-material 10 may not be fixed to the base material 20 and may move, and bonding force between the sub-material 10 and the base material 20 may be reduced. In particular, when applied to a product with strong vibration, such as an automobile, the sub-material 10 may be continuously shaken by the vibration, and the bonding force may be significantly reduced.

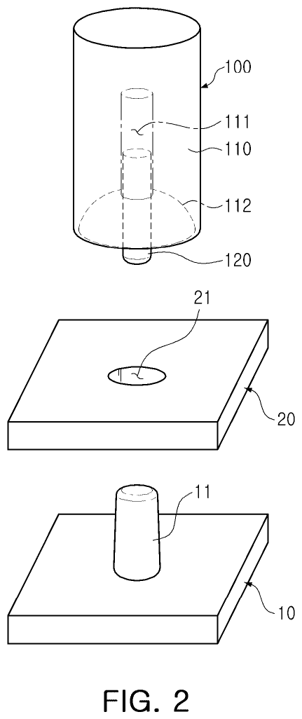

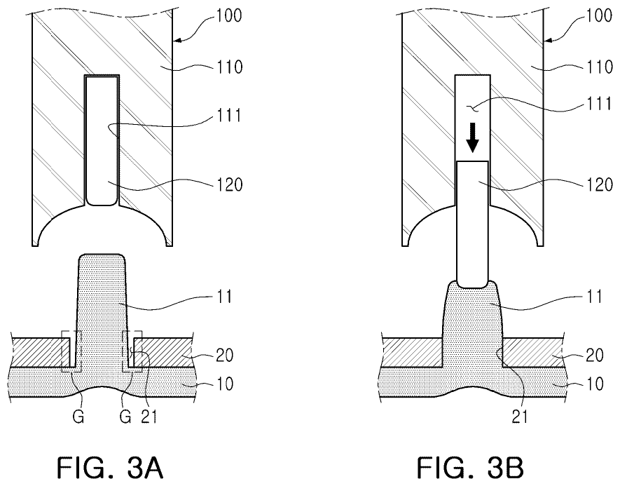

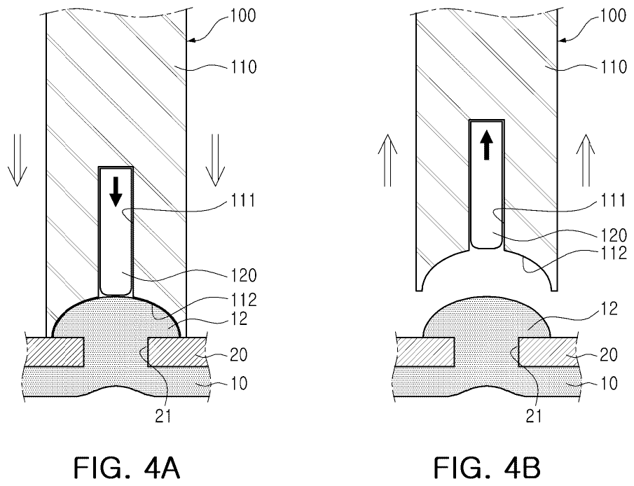

FIG. 2 is a perspective view illustrating a fusion tip 100 according to the present disclosure, and FIGS. 3A, 3B, 4A, and 4B are flowcharts illustrating heat fusion using the fusion tip 100 according to the present disclosure.

Referring to FIGS. 2 to 4B, the fusion tip 100 may include a base tip 110 and a fusion pin 120. In FIGS. 2 to 4B, a moving member 130 to be described below is omitted.

The base tip 110 occupies the largest portion of the fusion tip 100 and may surround the fusion pin 120 located in the center.

The base tip 110 may include a pinhole 111 formed vertically in the center. The pinhole 111 may be a space for accommodating the fusion pin 120. The shape of a cross-section of the pinhole 111 may be similar to a cross-section of the fusion pin 120.

The base tip 110 may include a tip head 112. The tip head 112 may be configured to contact the boss or rib 11 during heat fusion. For example, the tip head 112 may be located at the bottom of the base tip 110. The tip head 112 may have various shapes. For example, the tip head 112 may have a shape rounded toward the inside of the base tip 110. Therefore, after heat fusion, the boss or rib 11 may form a joining head 12 including a round shape in an upper portion. A cross-sectional area of the joining head 12 may be greater than a cross-sectional area of the insertion hole 21, so that the sub-material 10 and the base material 20 may be joined.

The fusion pin 120 may be configured to move up and down separately from the base tip 110. The fusion pin 120 may be positioned in the pinhole 111. The fusion pin 120 may move up and down while being inserted into the pinhole 111. At this time, the pinhole 111 may serve as a guide for the fusion pin 120 to move. The fusion pin 120 may move separately from the base tip 110. For example, the base tip 110 may be fixed without moving, and only the fusion pin 120 may move downwardly to press the boss or rib 11. Similarly, the base tip 110 may move while the fusion pin 120 is fixed. For example, while the fusion pin 120 presses the boss or rib 11 to be fixed, the base tip 110 may move downwardly to press the boss or rib 11.

The fusion pin 120 may first heat and press the central portion of the boss or rib 11 to fill the gap G. Hereinafter, the principle of filling the gap G will be described with reference to FIGS. 3A to 4B. FIGS. 3A to 4B illustrate heat fusion using the fusion tip 100 of the heat fusion machine according to the present disclosure and proceeds in the order of FIG. 3A to FIG. 4B.

Referring to FIGS. 3A to 4B, the heat fusion method may include an insertion operation, a first fusion operation, and a second fusion operation.

FIG. 3A illustrates a preparatory operation. The preparatory operation may be an operation of preparing the base material 20 in which a boss or rib 11 of the sub-material 10 is inserted into the insertion hole 21. For example, the boss or rib 11 formed on the sub-material 10 may be inserted into the insertion hole 21 formed in the base material 20. The cross-sectional area of the insertion hole 21 may be greater than the cross-sectional area of the boss or rib 11.

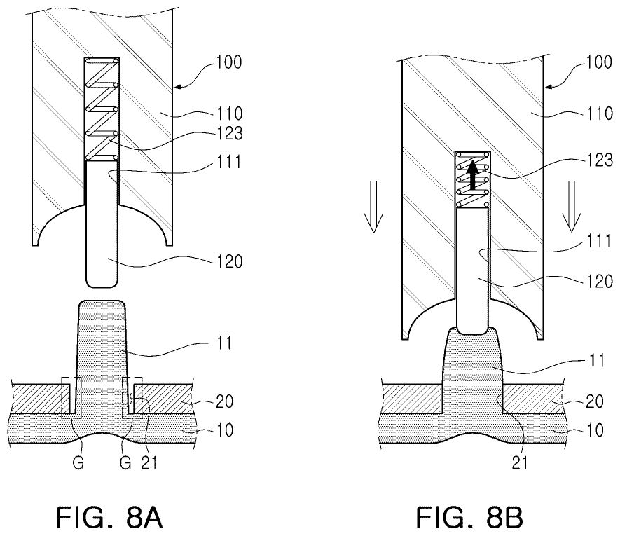

FIG. 3B illustrates a first fusion operation. The first fusion operation may be an operation of heating and pressing the boss or rib 11 with the fusion pin 120. Specifically, the central portion of the boss or rib 11 may be heated and pressed by the fusion pin 120. The first fusion operation may be an operation of heating and pressing the central portion of the boss or rib 11 to fill a space between the boss or rib 11 and the insertion hole 21 of the base material 20. In the first fusion operation, the boss or rib 11 may be heated and pressed by using the fusion tip 100 including the base tip 110 and the fusion pin 120 configured to move up and down separately from the base tip 110. The fusion pin 120 may be moved up and down separately from the base tip 110. In the first fusion operation, the fusion pin 120 may move downwardly to heat and press the central portion of the boss or rib 11, separately from the base tip 110. However, in the case of the fusion tip 100 including an elastic body 123 illustrated in FIG. 8, at least a portion of the fusion pin 120 may protrude from the pinhole 111. In the first fusion operation, the base tip 110 may not press the boss or rib 11 and only the fusion pin 120 may press the boss or rib 11. The central portion of the boss or rib 11 may be melted and moved downwardly. The melted boss or rib 11 may move horizontally, while moving downwardly. Therefore, the lower portion of the boss or rib 11 may be expanded horizontally and fill the gap G, an empty space between the boss or rib 11 and the insertion hole 21.

FIG. 4A illustrates a second fusion operation. The second fusion operation may be an operation of heating and pressing the remaining portion of the boss or rib 11 to fix the sub-material 10 and the base material 20. In the second fusion operation, the boss or rib 11 may be heated and pressed using the fusion tip 100 including the base tip 110 and the fusion pin 120 configured to move up and down while being separated from the base tip 110. In the second fusion operation, in a state in which the central portion of the boss or rib 11 is pressed by the fusion pin 120, the remaining portion of the boss or rib 11 may be heated and pressed by the base tip 110. The remaining portion here may be the remaining portion of the boss or rib 11 excluding the portion heated and pressed by the fusion pin 120. The base tip 110 may be lowered to heat and press the remaining portion. Here, the fusion pin 120 may be in a state of pressing the central portion of the boss or rib 11. That is, in a state in which the fusion pin 120 is fixed, the base tip 110 may be lowered to press the remaining portion. The remaining portion may be melted and deformed to correspond to the shape of the tip head 112 of the base tip 110 to form the joining head 12.

FIG. 4B illustrates a state in which the fusion is completed. The fusion tip 100 may be raised and the melted joining head 12 may be cooled. The joining head 12 may be cooled and solidified in a deformed state.

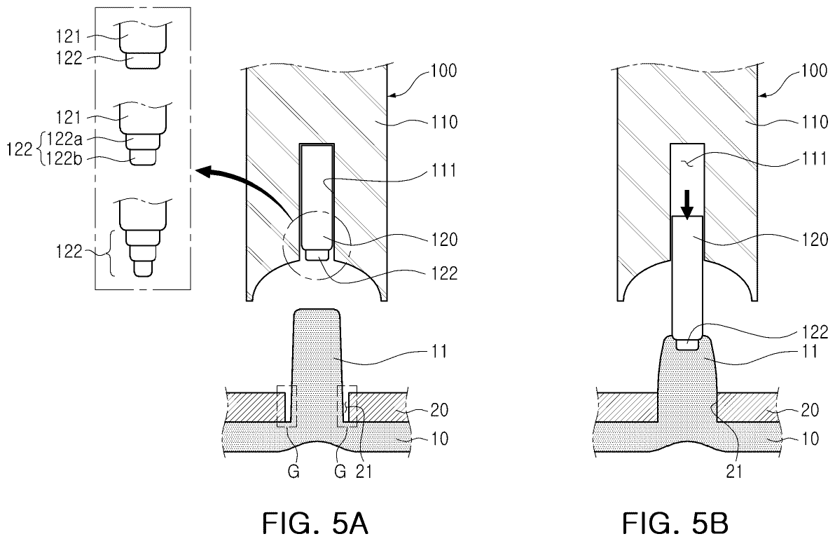

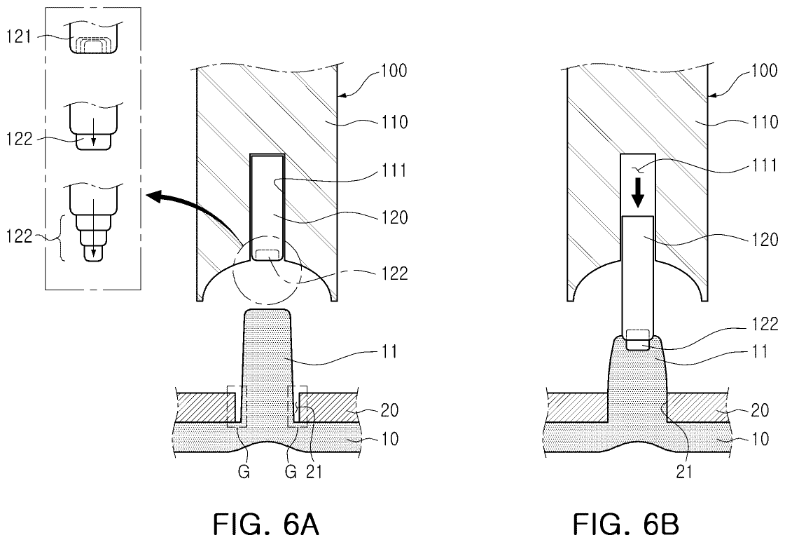

FIGS. 5A and 5B are cross-sectional views illustrating a modified example of a fusion pin 120, and FIGS. 6A and 6B are cross-sectional views illustrating another modified example of the fusion pin 120.

Referring to FIG. 5A to FIG. 6B, the fusion pin 120 may include a body portion 121 and an auxiliary pin 122. FIG. 5A and FIG. 6A are enlarged views of various modified examples of the fusion pin 120.

The body portion 121 may be a body of the fusion pin 120.

The auxiliary pin 122 may have a smaller cross-sectional area than the body portion 121. For example, when the cross-sections of the body portion 121 and the auxiliary pin 122 are circular, a diameter of the auxiliary pin 122 may be smaller than a diameter of the body portion 121. The auxiliary pin 122 may be arranged toward the boss or rib 11. The auxiliary pin 122 may face the boss or rib 11.

The auxiliary pin 122 may include a first auxiliary pin 122a having a smaller cross-sectional area than that of the body portion 121 and a second auxiliary pin 122b having a smaller cross-sectional area than that of the first auxiliary pin 122a. That is, the auxiliary pin 122 may sequentially include smaller auxiliary pins 122 as required. Accordingly, the auxiliary pin 122 may form an N-stage structure including several additional auxiliary pins 122. The first auxiliary pin 122a and the second auxiliary pin 122b may be arranged toward the boss or rib 11.

Referring to FIGS. 5A and 5B, the auxiliary pin 122 may be fixed while protruding toward the boss or rib 11. The first auxiliary pin 122a and the second auxiliary pin 122b may protrude and be fixed. For example, the first auxiliary pin 122a may protrude from the body portion 121 toward the boss or rib 11. In addition, the second auxiliary pin 122b may protrude from the first auxiliary pin 122a toward the boss or rib 11. The first auxiliary pin 122a and the second auxiliary pin 122b may protrude and be fixed. Accordingly, the body portion 121, the first auxiliary pin 122a, and the second auxiliary pin 122b of the fusion pin 120 may be arranged in order, and the cross-sectional areas thereof may have a step form which gradually decreases. The auxiliary pin 122 may include an N-th auxiliary pin, such as a third auxiliary pin, a fourth auxiliary pin, etc., as required, and may form an N-stage structure.

Referring to FIGS. 6A and 6B, the auxiliary pin 122 may be configured to be embedded in the body portion 121. The embedded auxiliary pin 122 may be configured to protrude toward the boss or rib 11 during heat fusion. Therefore, the auxiliary pin 122 may include a shape similar to that of the fusion tip 100 of FIG. 4 during heat fusion. Similarly, even when the auxiliary pin 122 is embedded, it may include an N-th auxiliary pin and form an N-stage structure. Although not shown in the drawing, the auxiliary pins may protrude, while embedded, in various manners. For example, each auxiliary pin may be individually combined with a spring, actuator structure, etc. to be described below and configured to move separately.

Through the N-stage structure of the auxiliary pin, the fusion pin 120 may intensively melt the central portion of the boss or rib 11 and push the same downwardly. For example, compared to a zero-stage structure without an auxiliary pin, a 2-stage structure may lower the central portion relatively more. The capacity of the boss or rib 11 that has been melted and moved downwardly may be sufficient to fill the gap G.

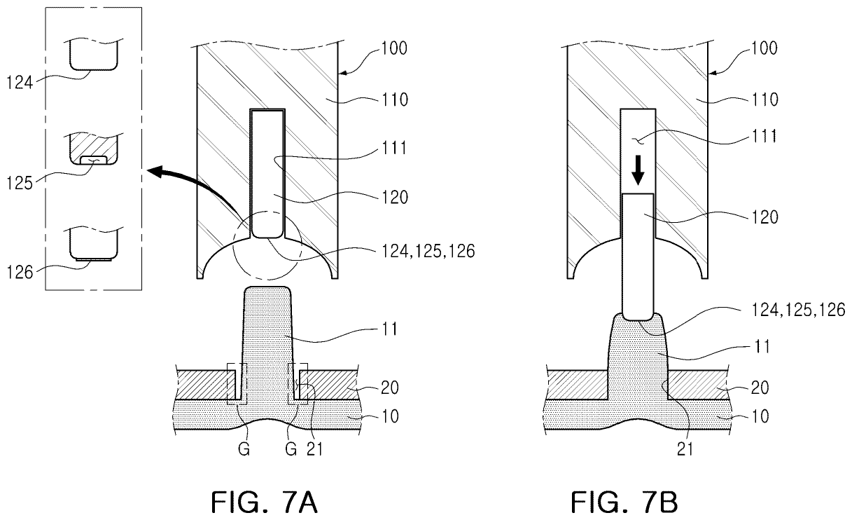

FIGS. 7A and 7B are cross-sectional views illustrating modified examples of the pin head 124 of the fusion pin 120.

Referring to FIGS. 7A and 7B, the fusion pin 120 may include a pin head 124.

The pin head 124 may be a portion of the fusion pin 120. The pin head 124 may contact the boss or rib 11. That is, the pin head 124 may be the end of the fusion pin 120.

FIG. 7A illustrates various shapes of the pin head 124. From the top, a general pin head 124, a pin head 124 including an intagliated portion 125, and a pin head 124 including a coating layer 126 are illustrated.

In general, a surface of the pin head 124 that contacts the boss or rib 11 may be a flat surface. However, the shape of the pin head 124 may be formed to vary.

The pin head 124 may include the intagliated portion 125. The intagliated portion 125 may be formed to be recessed into the interior of the fusion pin 120. The intagliated portion 125 may accommodate a portion of the melted boss or rib 11. The boss or rib 11 may have high viscosity even when melted. Therefore, the boss or rib 11 accommodated in the intagliated portion 125 may serve as a guide to prevent the fusion pin 120 from being displaced from a position thereof, while the fusion pin 120 is lowered.

The pin head 124 may further include the coating layer 126. The coating layer 126 may be formed on the surface of the pin head 124 contacting the boss or rib 11. The surface of the pin head 124 contacting the boss or rib 11 may be corroded or deformed due to contact with the melted boss or rib 11. Therefore, the pin head 124 may include the coating layer 126 to avoid the problem. The coating layer 126 may include various coating materials according to various purposes, such as chemical resistance, corrosion resistance, and discharge.

The shapes of the pin head 124 above are only examples and are not necessarily limited thereto, and the pin head 124 may include various shapes.

FIGS. 8A and 8B are cross-sectional views illustrating the fusion tip 100 including the elastic body 123.

Referring to FIGS. 8A and 8B, the fusion tip 100 may further include the elastic body 123. FIG. 8A illustrates a state before the elastic body 123 is compressed, and FIG. 8B illustrates a state after the elastic body 123 is compressed.

The elastic body 123 may be connected to the fusion pin 120. For example, one side of the elastic body 123 may be combined with the fusion pin 120, and the opposite side may be combined with the base tip 110. The elastic body 123 may be accommodated in the pinhole 111.

The elastic body 123 may be configured to be compressed during heat fusion so that the fusion pin 120 may be accommodated in the pinhole 111. For example, before heat fusion, the fusion pin 120 may be in a state in which at least a portion thereof is discharged outside the pinhole 111 due to the elasticity of the elastic body 123. When heat fusion begins, the fusion tip 100 may be lowered and the fusion pin 120 may first contact the boss or rib 11. Since the elastic body 123 has elasticity, the fusion pin 120 may press the boss or rib 11. The boss or rib 11 may have a greater resistance as it is pressed, and the elastic body 123 may contract due to the resistance. The fusion pin 120 may be completely accommodated in the pinhole 111 along with the contraction of the elastic body 123.

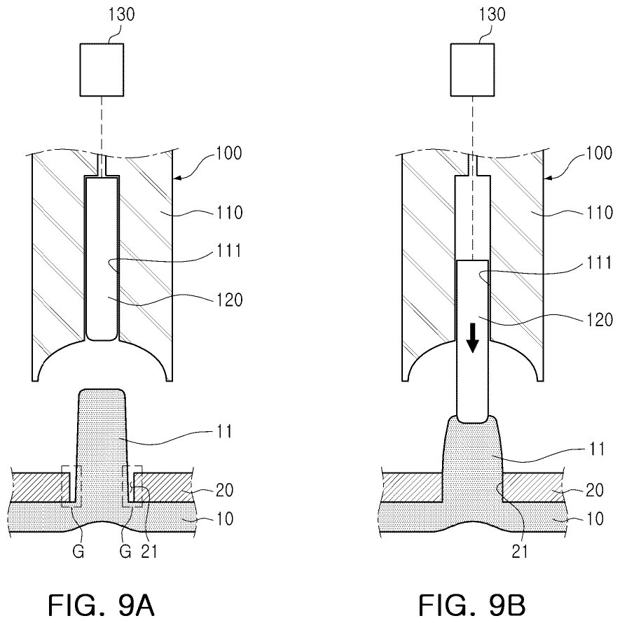

FIGS. 9A and 9B are cross-sectional views illustrating a portion of a heat fusion machine according to the present disclosure.

Referring to FIGS. 9A and 9B together with FIGS. 3A to 4B, the heat fusion machine may include the fusion tip 100 and the moving member 130.

The fusion tip 100 of the heat fusion machine may be any one of the aforementioned fusion tips 100.

The moving member 130 may be configured to move the fusion pin 120. The moving member 130 may be connected to the fusion pin 120 and may be configured to move the fusion pin 120 up and down.

The shape of the moving member 130 and the principle of moving the fusion pin 120 are not limited. Therefore, the following examples are examples of the moving member 130 and are not necessarily limited thereto.

The moving member 130 may include a motor and a driving shaft. The motor may rotate the driving shaft. The type of the motor is not limited and may be any motor that may exert sufficient rotational force to rotate the driving shaft. The driving shaft may be connected to the fusion tip and may rotate. As the driving shaft rotates, the fusion tip may move up and down. At this time, although not shown in the drawing, in order to prevent the fusion tip from rotating together with the driving shaft, a guide groove may be formed between the fusion pin 120 and the base tip 110. The motor and the driving shaft may move the fusion pin 120 up and down, and the fusion pin 120 may press the boss or rib 11.

In addition, the moving member 130 may include an actuator connected to the fusion pin 120. The actuator may move the fusion pin 120 up and down. For example, the actuator may include a piston structure. The actuator may move the piston to move the fusion pin 120 up and down. The piston may be combined with the fusion pin 120 to move the fusion pin 120 up and down. The actuator may inject or remove fluid or air through a hose. The actuator may move the piston by controlling hydraulic or pneumatic pressure to move the fusion pin 120.

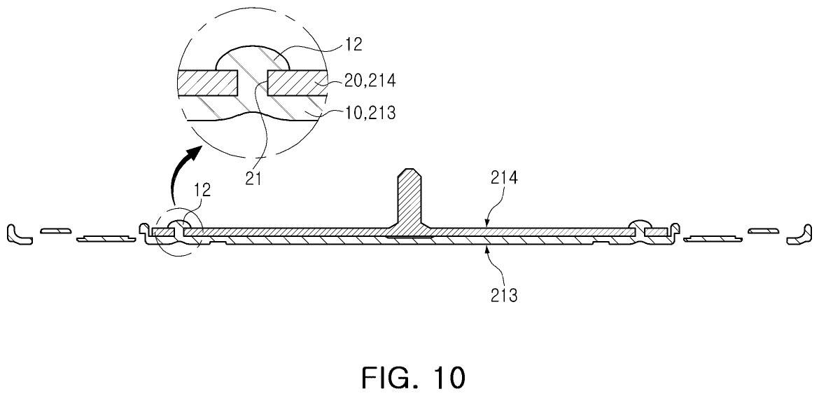

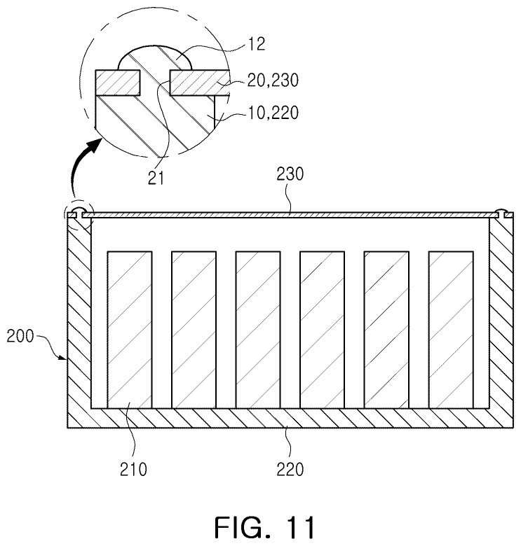

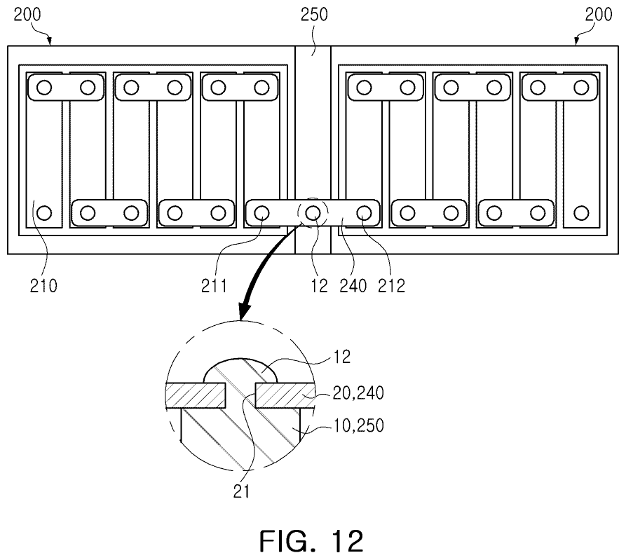

FIG. 10 is a cross-sectional view illustrating a portion of a battery cell 210 to which the heat fusion method according to the present disclosure is applied, FIG. 11 is a cross-sectional view illustrating a battery module 200 to which the heat fusion method according to the present disclosure is applied, and FIG. 12 is a plan view illustrating a battery pack to which the heat fusion method according to the present disclosure is applied.

FIGS. 10 to 12 illustrate examples of applying a heat fusion method according to the present disclosure to the manufacture of a battery assembly. FIGS. 10 to 12 illustrate enlarged cross-sectional views of the sub-material 10 and the base material 20 which are heat-fused and joined.

Referring to FIGS. 10 to 12, the heat fusion method according to the present disclosure may be applied to the manufacture of a battery assembly. For example, in the heat fusion method, the preparatory operation may be an operation of preparing the sub-material 10 and the base material 20 included in the battery assembly. The battery assembly may be a concept including the battery cell 210, the battery module 200, and a battery pack. The heat fusion method according to the present disclosure may be a method using the fusion tip 100 or a heat fusion machine according to the present disclosure.

The heat fusion method according to the present disclosure may be applied to the manufacture of the battery cell 210. For example, the sub-material 10 and the base material 20 may each be a component of one of the battery cells 210. The battery cell 210 may include an insulator 213 and a current collector 214. The insulator 213 may include an insulating material, such as plastic. The current collector 214 may include an electrically conductive material, such as metal. The insulator 213 and the current collector 214 may be joined to each other. The heat fusion method may be applied to join the current collector 214 and the insulator 213. At this time, the insulator 213 may be the sub-material 10, and the current collector 214 may be the base material 20. The insulator 213 may include the boss or rib 11, and the collector plate 214 may include the insertion hole 21. The boss or rib 11 of the insulator 213 may be inserted into the insertion hole 21 of the collector plate 214 and then heat-fused.

The heat fusion method according to the present disclosure may be applied to the manufacture of the battery module 200. The sub-material 10 and the base material 20 may each be a component of the battery module 200 or a battery pack. The battery module 200 may include a plurality of battery cells 210 and a housing. The battery module 200 may accommodate a plurality of battery cells 210. Each battery cell 210 may be a secondary battery. The battery module 200 may include a housing including a lower frame 220 and an upper frame 230. The lower frame 220 may include an empty space therein to accommodate the plurality of battery cells 210. After the plurality of battery cells 210 are accommodated in the lower frame 220, the upper frame 230 may be joined to the lower frame 220.

The heat fusion method may be applied in the process of joining the upper frame 230 to the lower frame 220. For example, the boss or rib 11 may be formed in an upper portion of the lower frame 220. The upper frame 230 may include the insertion hole 21 into which the boss or rib 11 may be inserted. At this time, the lower frame 220 may be the sub-material 10, and the upper frame 230 may be the base material 20. After inserting the boss or rib 11 of the lower frame 220 into the insertion hole 21, heat fusion may be performed using the fusion tip 100 or the heat fusion machine according to the present disclosure. The upper frame 230 and the lower frame 220 may be joined by the heat fusion method.

The heat fusion method according to the present disclosure may be applied to the manufacture of a battery pack. The battery pack may include a plurality of battery modules 200, a reinforcing member 250, and a busbar 240.

The busbar 240 may be a component electrically connecting a plurality of battery cells 210 or a plurality of battery modules 200. For example, the busbar 240 may be electrically connected to a negative terminal 211 of a battery cell and a positive terminal 212 of an adjacent battery cell. The reinforcing member 250 may be a frame located between the plurality of battery modules 200. The reinforcing member 250 may provide additional fixing force to the plurality of battery modules 200 or busbars 240. For example, the reinforcing member 250 may include the boss or rib 11, and the busbar 240 may include the insertion hole 21 into which the boss or rib 11 is inserted. At this time, the reinforcing member 250 may be the sub-material 10 and the busbar 240 may be the base material 20. After the boss or rib 11 of the reinforcing member 250 is inserted into the insertion hole 21 of the busbar 240, heat fusion may be performed using the fusion tip 100 or the heat fusion machine according to the present disclosure. The busbar 240 may be joined to the reinforcing member 250 by the heat fusion method.

The above examples are only some examples to which the heat fusion method is applied. Therefore, the heat fusion method according to the present disclosure may also be applied to other components of the battery module 200 or the battery pack.

According to an embodiment of the present disclosure, the gap formed between the sub-material and the base material may be reduced.

According to an embodiment of the present disclosure, a heat fusion method capable of increasing bonding strength may be provided.

Only specific examples of implementations of certain embodiments are described. Variations, improvements and enhancements of the disclosed embodiments and other embodiments may be made based on the disclosure of this patent document.

What is claimed is:

1. A fusion tip of a heat fusion machine assembling a sub-material including a boss or rib with a base material and then heat-fusing the boss or rib to fix the sub-material and the base material, the fusion tip comprising:
a base tip including a pinhole formed vertically in a center and a tip head contacting the boss or rib during heat fusion; and
a fusion pin positioned in the pinhole and configured to move up and down separately from the base tip.

2. The fusion tip of claim 1, wherein the fusion pin includes a body portion and an auxiliary pin, and the auxiliary pin has a cross-sectional area smaller than that of the body portion and is disposed toward the boss or rib.

3. The fusion tip of claim 2, wherein
the auxiliary pin includes a first auxiliary pin having a cross-sectional area smaller than that of the body portion and a second auxiliary pin having a cross-sectional area smaller than that of the first auxiliary pin, and
the first auxiliary pin and the second auxiliary pin are arranged toward the boss or rib.

4. The fusion tip of claim 2, wherein the auxiliary pin protrudes toward the boss or rib to be fixed.

5. The fusion tip of claim 2, wherein the auxiliary pin is embedded in the body portion and is configured to protrude toward the boss or rib during heat fusion.

6. The fusion tip of claim 1, wherein the fusion pin includes a pin head contacting the boss or rib, and the pin head includes an intagliated portion recessed into the interior of the fusion pin.

7. The fusion tip of claim 1, wherein the fusion pin includes a pin head contacting the boss or rib, and the pin head includes a coating layer on a surface contacting the boss or rib.

8. The fusion tip of claim 1, further comprising:
an elastic body connected to the fusion pin,
wherein the elastic body is configured to be compressed during heat fusion so that the fusion pin is accommodated in the pinhole.

9. A heat fusion machine assembling a sub-material including a boss or rib with a base material and then heat-fusing the boss or rib to fix the sub-material and the base material, the heat fusion machine comprising:
a fusion tip; and
a moving member,
wherein the fusion tip includes:
a base tip including a pinhole formed vertically in a center and a tip head contacting the boss or rib during heat fusion; and
a fusion pin positioned in the pinhole and configured to move up and down separately from the base tip, and
wherein the moving member is connected to the fusion pin and configured to move the fusion pin up and down.

10. The heat fusion machine of claim 9, wherein
the moving member includes a motor and a driving shaft connected to the fusion pin, and
the motor rotates the driving shaft to move the fusion pin up and down.

11. The heat fusion machine of claim 9, wherein
the moving member includes an actuator connected to the fusion pin, and
the actuator moves the piston to move the fusion pin up and down.

12. A heat fusion method comprising:
a preparatory operation of preparing a base material having an insertion hole into which a boss or rib of a sub-material is inserted;
a first fusion operation of heating and pressing a central portion of the boss or rib to fill a space between the boss or rib and the insertion hole of the base material; and
a second fusion operation of heating and pressing the remaining portion of the boss or rib to fix the sub-material and the base material,
wherein, in the first fusion operation and the second fusion operation, the boss or rib is heated and pressed using a fusion tip including a base tip and a fusion pin configured to move up and down separately from the base tip.

13. The heat fusion method of claim 12, wherein, in the first fusion operation, the fusion pin moves downwardly separately from the base tip to heat and press the central portion of the boss or rib.

14. The heat fusion method of claim 13, wherein, in the second fusion operation, the remaining portion of the boss or rib is heated and pressed with the base tip, while the central portion of the boss or rib is pressed with the fusion pin.

15. The heat fusion method of claim 12, wherein the preparatory operation is an operation of preparing the sub-material and the base material included in a battery assembly.
